(19) United States
(12) Patent Application Publication
(10) Pub. No.: US 2007/0030494 A1
(43) Pub. Date: Feb. 8, 2007

(54) Image forming apparatus

(75) Inventor: Tadaharu Kusumi, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/489,686

(22) Filed: Jul. 20, 2006

(30) Foreign Application Priority Data
Jul. 22, 2005 (JP) 2005-212905

(51) Int. Cl. G06K 15/22

(52) U.S. Cl. 358/1.3

(57) ABSTRACT

In a copier 1, when RFID wireless communication is performed between a first transmitter-receiver 18 and a wireless tag 21 fitted to a toner container 20, based on a table in which different transmission output values of the first transmitter-receiver 18 are written from the lower limit value to the upper limit value, wireless communication is first performed at the lower limit transmission output value, and if a CPU 10 finds that RFID wireless communication is not being performed properly, the first transmitter-receiver increases its transmission output stepwise according to the table until proper wireless communication is achieved.

This application is based on Japanese Patent Application No. 2005-212905 filed on Jul. 22, 2005, the contents of which are hereby incorporated by reference.

### BACKGROUND OF THE INVENTION

1. Field of the Invention

The present invention relates to reduction of leakage, out of an image forming apparatus, of electromagnetic wave noise that is emitted from RFID (radio-frequency identification) adopted in the image forming apparatus.

2. Description of Related Art

Electromagnetic wave noise emitted from an electronic device adversely affects other electronic devices, and hence its emission is restricted with various standards (for example, those formulated by the Special International Committee on Radio Interference, with a French acronym “CISPR”). In image forming apparatuses, RFID compatible with such standards directed to electromagnetic wave noise is commonly adopted: typically, a reader/writer module (hereinafter referred to as R/W module) is fitted to the main body of an image forming apparatus, and a wireless tag having a memory is fitted to a replacement part thereof, for example, a consumable component such as a cartridge, a toner container, etc. Here, RFID is used for the management of replacement parts, that is, for the management of the models, part numbers, etc.

Now, how RFID operates will be described. To write data to the memory of a wireless tag, an R/W module generates electromagnetic waves containing a write instruction and data; activated on receiving the electromagnetic waves, the wireless tag writes the data to the memory according to the write instruction. On the other hand, to read data from the memory of the wireless tag, the R/W module generates electromagnetic waves containing a read instruction; activated on receiving the electromagnetic waves, the wireless tag reads the data stored in the memory and transmits it to the R/W module according to the read instruction.

Hence, in RFID wireless communication, the farther an R/W module and a wireless tag are apart from each other, the higher transmission output is required in the electromagnetic waves emitted from the R/W module. Also, as the inclination of a wireless tag with respect to an R/W module varies, the transmission output at which the electromagnetic waves need to be transmitted to achieve wireless communication varies.

As described above, in conventional image forming apparatuses adopting RFID, wireless tags are fitted to replacement parts such as consumable components; hence variations such as those in the fitting positions of wireless tags, in the fitting positions of replacement parts, and in the reception sensitivities of wireless tags are taken into consideration, and the transmission output value of the R/W module is set to be the maximum value thereof that does not permit the just-mentioned variations to cause failure in RFID wireless communication.

As a patent document related to RFID, JP-A-2005-78100 discloses and proposes a tag data reading apparatus.

Certainly, in the image forming apparatus structured as described above, variations such as those in the fitting positions of wireless tags, in the fitting positions of replacement parts, and in the reception sensitivities of the wireless tags are taken into consideration and the transmission output value of the R/W module is set to be the maximum value thereof that does not cause failure in RFID wireless communication, resulting in satisfactory RFID wireless communication between the R/W module and the wireless tags.

However, in conventional image forming apparatuses, as a result of the transmission output value of the R/W module being set to be the maximum value thereof that, with variations taken into consideration, does not cause failure in wireless communication between the R/W module and the wireless tags, constant strong electromagnetic waves are outputted from the R/W module all the time without regard to the communication condition between the R/W module and the wireless tags, resulting in an unnecessary leakage and emission of electromagnetic wave noise out of the main body of the apparatus.

### SUMMARY OF THE INVENTION

In view of the above described problems, an object of the present invention is to provide an image forming apparatus capable of reducing unnecessary leakage of electromagnetic wave noise out of the main body of the image forming apparatus during wireless communication with a wireless tag.

To achieve the above object, according to the present invention, an image forming apparatus is provided with: a replacement part to which a wireless tag is fitted and that is detachable from a main body of the image forming apparatus; a transmitter-receiver that performs wireless communication with the wireless tag; and a checking portion for checking whether or not the transmitter-receiver is properly performing communication with the wireless tag. Here, if the checking portion finds that the transmitter-receiver is not properly performing wireless communication with the wireless tag, the transmitter-receiver increases its transmission output stepwise and performs wireless communication. Incidentally, the transmitter-receiver here refers to a first transmitter-receiver 18 (see FIG. 1) that is fitted to the main body of the image forming apparatus.

With this structure, when wireless communication is performed between the transmitter-receiver and the wireless tag, the transmission output is gradually increased according to the wireless communication condition so that wireless communication is performed at the minimum necessary transmission output. This helps reduce unnecessary leakage of electromagnetic wave noise out of the main body of the apparatus.

According to the present invention, the image forming apparatus structured as described above may be further provided with a memory portion that stores a table in which a plurality of transmission output values are written stepwise from the lower limit value to the upper limit value thereof. Here, the transmitter-receiver first performs wireless communication with the wireless tag at the lower limit transmission output value written in the table, and if the transmitter-receiver is found by the checking portion not to be properly performing wireless communication with the wireless tag, the transmitter-receiver increases its transmission output stepwise according to the table and performs wireless communication.

With this structure, when wireless communication is performed, the transmission output does not exceed the upper limit thereof, and thus electromagnetic wave noise is surely prevented from leaking out of the main body of the apparatus.

According to the present invention, in the image forming apparatus structured as described above, when the transmitter-receiver is found by the checking portion to be properly performing wireless communication with the wireless tag, wireless communication is thereafter performed at the transmission output value then being used.

With this structure, since the transmission output value at the time when proper wireless communication is achieved is used as the transmission output value for wireless communication from then on, it is possible to simplify the control for setting the transmission output value and thereby to shorten the time required for wireless communication.

According to the present invention, in the image forming apparatus structured as described above, when the transmitter-receiver performs wireless communication with the wireless tag at the upper limit transmission output value written in the table, and if the transmitter-receiver is found by the checking portion not to be properly performing wireless communication with the wireless tag, the transmitter-receiver may suspend wireless communication.

With this structure, even when the replacement part is improperly fitted, wireless communication does not need to be unnecessarily repeated at the upper limit transmission output value. This helps reduce the leakage of electromagnetic wave noise more effectively.

### BRIEF DESCRIPTION OF THE DRAWINGS

FIG. 1 is a block diagram showing the structure of a principal part of a copier according to the present invention;

FIG. 2 is a vertical sectional view schematically showing the structure of a principal part of a copier according to the present invention;

FIG. 3 is a graph showing an example of the relationship between the distance from a first antenna 19 to a wireless tag 21 and the transmitting output of a first transmitter-receiver 18 in a copier 1 embodying the present invention;

FIG. 4 is a graph showing an example of the relationship between the transmission output of the first transmitter-receiver 18 and the electromagnetic wave noise produced in the copier 1 embodying the present invention; and

FIG. 5 is a flow chart showing how wireless communication is performed between the first transmitter-receiver 18 and the wireless tag 21 in the copier 1 embodying the present invention.

### DETAILED DESCRIPTION OF PREFERRED EMBODIMENTS

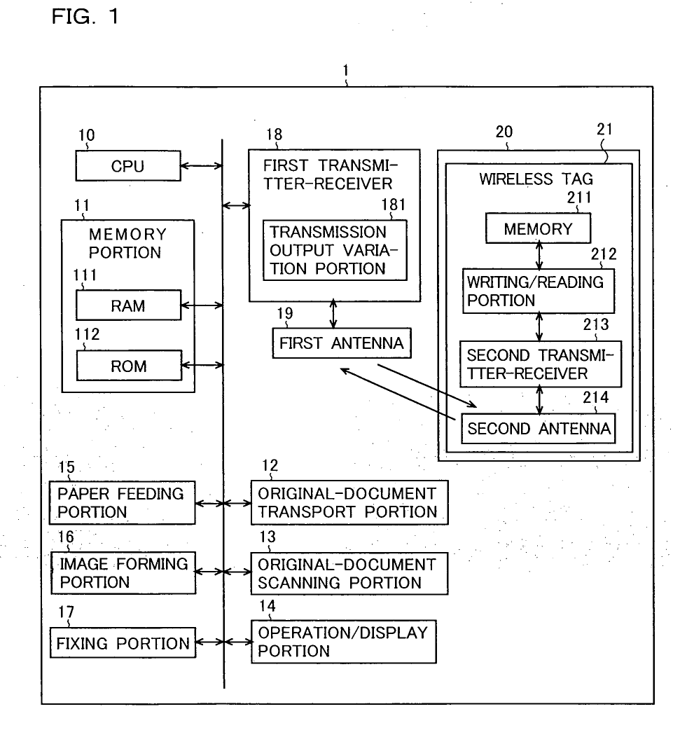

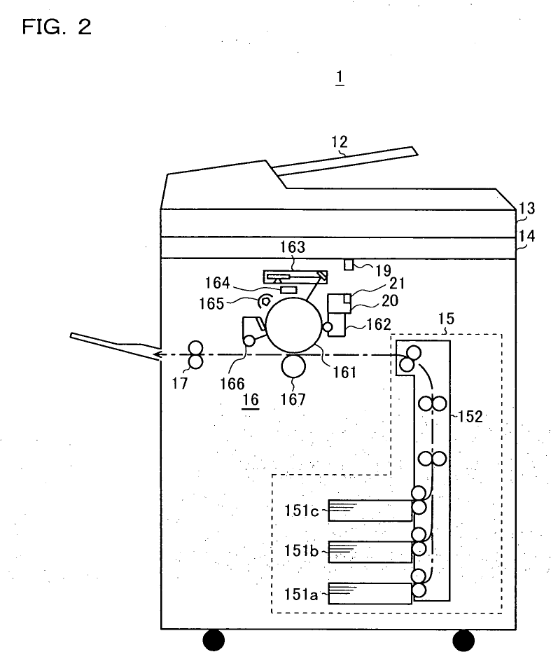

Hereinafter, an embodiment of the present invention will be described that deals with a case in which the present invention is applied to a copier. FIG. 1 is a block diagram showing the structure of a principal part of a copier according to the present invention and FIG. 2 is a vertical sectional view schematically showing the structure of a principal part of the copier according to the present invention. As shown in FIGS. 1 and 2, the copier 1 of this embodiment is provided with:

a central processing unit 10 (hereinafter referred to as CPU 10) for controlling the operation of the whole apparatus;

a memory portion 11 for storing a variety of control programs, data, and the like, and also for use as a work area;

a first transmitter-receiver 18 for performing RFID wireless communication with a wireless tag (described later);

a first antenna 19 that emits the transmission output of the first transmitter-receiver 18 into the air as electromagnetic waves and that receives the electromagnetic waves emitted from the wireless tag 21 (described later) to feed them to the first transmitter-receiver 18 as reception signals;

a toner container 20 that is detachable and in which toner is stored to be fed to a developing device 162 of an image forming portion 16 (described later);

a wireless tag 21 that is fitted to the toner container 20 and that performs RFID wireless communication;

an original-document transport portion 12 for automatically transporting an original document;

an original-document scanning portion 13 for scanning the original document having been transported by the original-document transport portion 12 in order to generate image data thereof;

an operation/display portion 14 composed of operation means such as a numeric keypad and a touch panel and display means such as a liquid crystal display;

an image forming portion 16 that outputs a toner image based on the image data onto paper;

a paper feeding portion 15 for feeding paper to the image forming portion 16; and

a fixing portion 17 for fixing on the paper the toner image obtained at the image forming portion 16.

The first transmitter-receiver 18 and the first antenna 19 correspond to the above mentioned R/W module.

The CPU 10 not only controls the operation of the whole apparatus, but also controls communication performed by the first transmitter-receiver 18, which will later be described in detail. The CPU 10 further serves as a checking portion for checking whether or not the first transmitter-receiver 18 is properly performing wireless communication with the wireless tag 21.

The memory portion 11 is provided with: a RAM (random access memory) 111 that is used as a work area when the CPU 10 carries out various controls; and a ROM (read only memory) 112 in which various control programs and various kinds of data are stored.

In the ROM 112 are stored: a table in which different transmission output values of the first transmitter-receiver 18 are written from the lower limit value to the upper limit value at predetermined numerical intervals; and confirmation data for confirming whether or not RFID communication is being properly performed between the first transmitter-receiver 18 and the wireless tag 21.

The transmission output values of the first transmitter-receiver 18 written in this table are obtained in the following way, taking into consideration variations such as those in the fitting position of the wireless tag 21 on the toner container 20 and in the fitting position of the toner container 20: while the fitting position of the wireless tag 21 on the toner container 20, the fitting position of the toner container 20, and the like are varied and measured, the minimum transmission value of the first transmitter-receiver 18 that permits proper wireless communication between the first transmitter-receiver 18 and the wireless tag 21 in each measuring condition is selected as the transmission output values of the first transmitter-receiver 18 written in the table.

In the table stored in the ROM 112, as different transmission output values of the first transmitter-receiver 18, the values 80 mW, 100 mW, and 120 mW are written based on the just-mentioned measurement. The values written in the table stored in the ROM 112 are not limited to 80 mW, 100 mW, and 120 mW, and may be varied according to, for example, the condition of the apparatus.

The first transmitter-receiver 18 is provided with a transmission output variation portion 181 for varying the transmission output of electromagnetic waves emitted from the first antenna 19 to the wireless tag 21 according to a transmission-value-set instruction from the CPU 10.

When the first transmitter-receiver 18 receives data, a write instruction to write the data to the wireless tag 21, and a transmission-output-set instruction from the CPU 10, it converts the data and the write instruction to transmission signals based on RFID. Subsequently, the first transmitter-receiver 18 makes the first antenna 19 emit electromagnetic waves including the write instruction and data at the transmission output value set by the transmission output variation portion 181 based on the transmission-output-set instruction.

When the CPU 10 feeds a read instruction to read data from the wireless tag 21 and a transmission-output-set instruction to the first transmitter-receiver 18, the first transmitter-receiver 18 converts the read instruction to transmission signals based on RFID and makes the first antenna 19 emit electromagnetic waves including the read instruction at the transmission output value set by the transmission output variation portion 181 based on the transmission-output-set instruction.

As shown in FIG. 2, the toner container 20 is fitted in a position where it can feed toner to the developing device 162 (described later). The toner container 20 is detached by the user when the toner therein is used up, and a new toner container 20 is fitted in the fitting position thereof shown in FIG. 2.

The wireless tag 21 is provided with:

an electrically writable/erasable nonvolatile memory 211 for storing data transmitted from the first transmitter-receiver 18 via the first antenna 19;

a writing/reading portion 212 for writing data in the memory 211 according to a write instruction from the first transmitter-receiver 18 and for reading data from the memory 211 according to a read instruction from the first transmitter-receiver 18;

a second antenna 214 that receives electromagnetic waves based on RFID emitted from the first antenna 19 and feeds them to a second transmitter-receiver 213 (described later) as reception signals and that emits transmission signals fed from the second transmitter-receiver 213 (described later) into space as electromagnetic waves; and

the second transmitter-receiver 213 for performing RFID wireless communication with the first transmitter-receiver 18 via the first and second antennas 19 and 214.

The second transmitter-receiver 213 converts reception signals based on RFID that it has received via the first and second antennas 19 and 214 (that is, a write instruction, a read instruction, data, and the like) into reception signals for the writing/reading portion 212, and converts data from the memory 211 fed through the writing/reading portion 212 into transmission signals based on RFID to permit them to be emitted as electromagnetic waves from the second antenna 214. The second transmitter-receiver 213 is further provided with a power generation portion (not shown) that uses electromagnetic waves received by the second antenna 214 to generate electric power for operating the wireless tag 21. Incidentally, the wireless tag 21 may be provided with a power source such as a battery instead of the power generation portion.

The paper feeding portion 15 is provided with: a plurality of tiers (in this embodiment, three tiers) of paper storage portions 151a to 151c; and a paper transporting portion 152 that serves as a common paper transporting passage through which paper is transported from one of the paper storage portions 151a to 151c to the image forming portion 16.

As shown in FIG. 2, the image forming portion 16 is provided with:

a photoconductive drum 161, serving as a latent image carrying member, on the surface of which a toner image is formed based on image data;

a charger 164 for uniformly charging the surface of the photoconductive drum 161 at a predetermined electric potential;

an exposure unit 163 for forming an electrostatic latent image on the surface of the photoconductive drum 161 by irradiating it with laser light based on the image data;

the developing device 162 for forming a toner image on the surface of the photoconductive drum 161 from an electrostatic latent image formed on the surface of the photoconductive drum 161;

a transfer roller 167 for electrostatically transferring a toner image formed on the surface of the photoconductive drum 161 onto paper that has been transported;

a cleaning portion 166 for removing toner remaining on the surface of the photoconductive drum 161; and

a neutralization device 165 for neutralizing the surface of the photoconductive drum 161.

Next, the operation performed to copy an original document in the copier 1 structured as described above will be described. In the original-document copying operation of the copier 1 of this embodiment, first when an original document is transported from the original-document transport portion 12 to the original-document scanning portion 13, the original document is scanned by the original-document scanning portion 13, and thus image data is formed. The formed image data is temporarily stored in the memory 11, and then is read therefrom to be fed to the image forming portion 16. Subsequently, an image starts to be formed at the image forming portion 16, and the exposure unit 163 forms an electrostatic latent image based on the image data on the surface of the photoconductive drum 161 which has been uniformly charged at a predetermined electric potential by the charger 164. Subsequently, the developing device 162 forms a toner image from this electrostatic latent image on the surface of the photoconductive drum 161. The toner image formed on the surface of the photoconductive drum 161 is transferred by the transfer roller 167 onto paper that has been transported from the paper feeding portion 15.

Thereafter, the paper carrying the unfixed toner image is fed to the fixing portion 17 to be heated and pressed there and is then ejected therefrom. Incidentally, the solid line arrow in FIG. 2 indicates the paper transport passage.

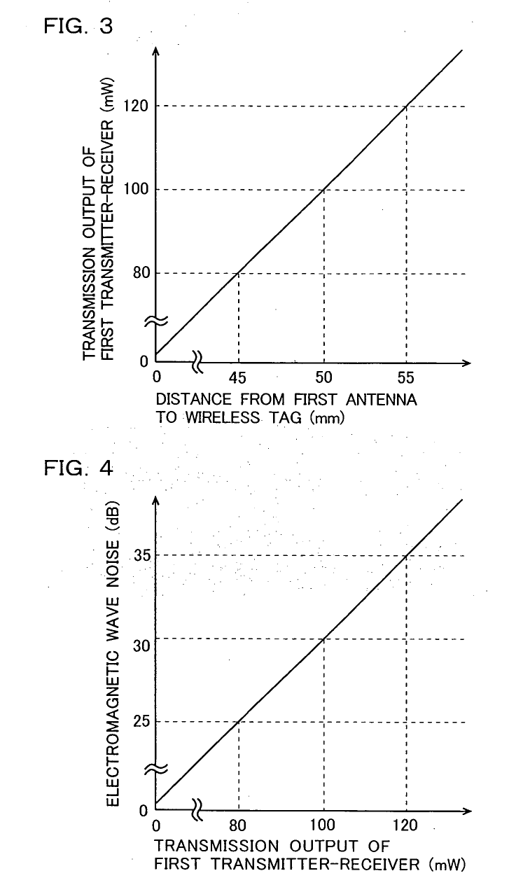

Next, the behavior of the RFID wireless communication between the first transmitter-receiver 18 and the wireless tag 21 in the copier 1 structured as described above will be described. FIG. 3 is a graph showing an example of the relationship between the distance from the first antenna 19 to the wireless tag 21 and the transmission output of the first transmitter-receiver 18 in the copier 1 of this embodiment. FIG. 4 is a graph showing an example of the relationship between the transmission output of the first transmitter-receiver 18 and the electromagnetic wave noise produced in the copier 1 of this embodiment. The electromagnetic wave noise values in FIG. 4 are those actually measured outside the main body of the apparatus with the transmission output of the first transmitter-receiver 18 emitted as electromagnetic waves from the first antenna 19.

As shown in FIG. 3, in the copier 1 of this embodiment, when the distance between the first antenna 19 and the wireless tag 21 is 45 mm, the transmission output of the first transmitter-receiver 18 needs to be 80 mW to achieve proper wireless communication between the first transmitter-receiver 18 and the wireless tag 21. When the distance between the first antenna 19 and the wireless tag 21 is 50 mm and 55 mm, the transmission outputs of the first transmitter-receiver 18 need to be 100 mW and 120 mW, respectively, to achieve proper wireless communication between the first transmitter-receiver 18 and the wireless tag 21.

As shown in FIG. 4, in the copier 1 of this embodiment, when the transmission output of the first transmitter-receiver 18 is 80 mW, the amount of electromagnetic wave noise that unnecessarily leaks out of the main body of the apparatus is 25 dB. When the transmission outputs of the first transmitter-receiver 18 are 100 mW and 120 mW, the amounts of electromagnetic wave noise that unnecessarily leaks out of the main body of the apparatus are 30 dB and 35 dB, respectively.

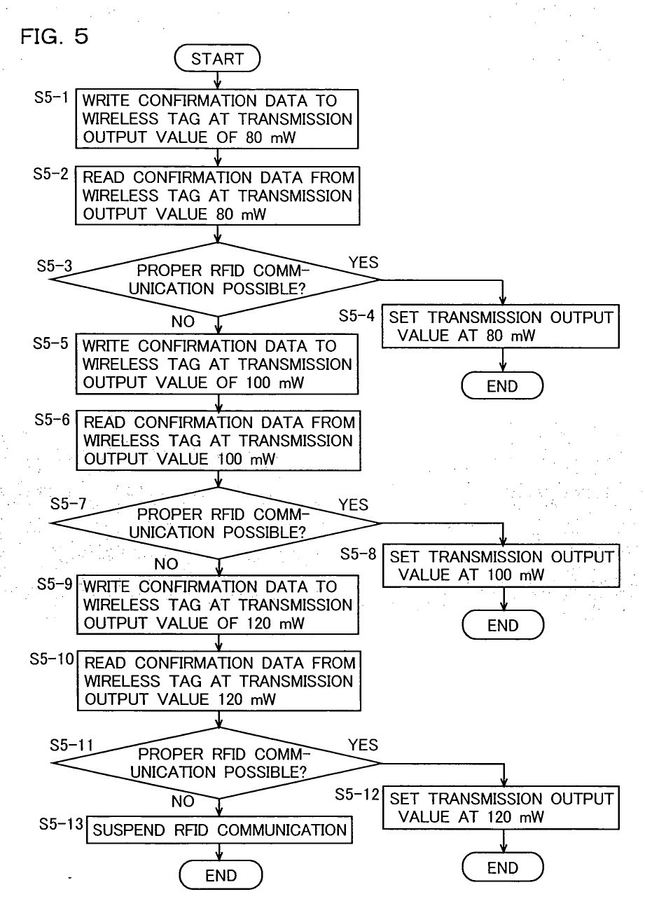

Next, how RFID wireless communication is performed between the first transmitter-receiver 18 and the wireless tag 21 will be described with reference to the relevant figures. FIG. 5 is a flow chart showing how wireless communication is performed between the first transmitter-receiver 18 and the wireless tag 21 in the copier 1 of this embodiment. The following description deals with cases in which the transmission output values of the first transmitter-receiver 18 written in the table stored in the ROM 112 of the copier 1 are 80 mW, 100 mW, and 120 mW.

In the copier 1 of this embodiment, as shown in FIGS. 1 and 5, in step S5-1, if the CPU 10, according to the control program stored in the ROM 112, finds that wireless communication needs to be performed between the first transmitter-receiver 18 and the wireless tag 21 (for example, in order to check the type of the new toner container 20 with which the old one has just been replaced), the CPU 10 feeds the transmission output variation portion 181 with a transmission-output-set instruction to set the transmission output at 80 mW. Then, according to this transmission-output-set instruction, the transmission output of the transmission output variation portion 181 is set at 80 mW.

Then, the CPU 10 feeds the first transmitter-receiver 18 with a write instruction and confirmation data stored in the ROM 112, and the first transmitter-receiver 18 converts the write instruction and the confirmation data into transmission signals compatible with RFID. Then, the first transmitter-receiver 18 makes the first antenna 19 emit electromagnetic waves, at the transmission output of 80 mW, including the converted write instruction and confirmation data.

On the other hand, the wireless tag 21 is activated by the electromagnetic waves received by the second antenna 214. The second transmitter-receiver 213 feeds the writing/reading portion 212 with the write instruction that the second transmitter-receiver 213 has read from the reception signals fed thereto through the second antenna 214. Then, according to the write instruction, the writing/reading portion 212 writes the confirmation data in the memory 211.

Subsequently, in step S5-2, the CPU 10 feeds a read instruction to the first transmitter-receiver 18, and the first transmitter-receiver 18 converts the read instruction into transmission signals compatible with RFID. The first transmitter-receiver 18 makes the first antenna 19 emit electromagnetic waves including the converted read instruction at the transmission output of 80 mW.

On the other hand, the wireless tag 21 is activated on receiving the electromagnetic waves. The second transmitter-receiver 213 feeds the writing/reading portion 212 with the read instruction that the second transmitter-receiver 213 has read from reception signals fed thereto through the second antenna 214. Then, according to the read instruction, the writing/reading portion 212 reads the confirmation data stored in the memory 211, and feeds the confirmation data to the second transmitter-receiver 213. Then, the second transmitter-receiver 213 makes the second antenna 214 emit an electromagnetic waves including the confirmation data.

Then, when the first antenna 19 receives the electromagnetic waves including the confirmation data and feeds them to the first transmitter-receiver 18 as reception signals, the first transmitter-receiver 18 converts the reception signals, which are compatible with RFID, into reception confirmation data, and then the CPU 10 stores this data in the RAM 111.

Subsequently, in step S5-3, the CPU 10 compares the confirmation data stored in the ROM 112 with the reception confirmation data that has just been stored in the RAM 111. If it is found that the two pieces of data are identical and that the first transmitter-receiver 18 and the wireless tag 21 are properly performing RFID wireless communication (S5-3 YES), the transmission output of the first transmitter-receiver is set at 80 mW in step S5-4, and wireless communication between the first transmitter-receiver 18 and the wireless tag 21 from then on is performed at 80 mW.

In step S5-3, if the CPU 10 finds that the two pieces of data are not identical and that the first transmitter-receiver 18 and the wireless tag 21 are not properly performing RFID wireless communication, or if, a predetermined time after electromagnetic waves including a read instruction is emitted from the first antenna 19 in step S5-2, electromagnetic waves including confirmation data emitted from the wireless tag 21 have not been fed to the first transmitter-receiver 18 as reception signals and the CPU 10 finds that the first transmitter-receiver 18 and the wireless tag 21 are not properly performing RFID wireless communication (S5-3, NO), the CPU 10 then, in step S5-5 sets the transmission output of the first transmitter-receiver 18 at 100 mW according to the table stored in the ROM 112. Then, the CPU 10 feeds the first transmitter-receiver 18 with a write instruction and confirmation data stored in the ROM 112, and the first transmitter-receiver 18 converts the write instruction and the confirmation data into transmission signals compatible with RFID. Then, the first transmitter-receiver 18 makes the first antenna 19 emit electromagnetic waves, at the transmission output of 100 mW, including the converted write instruction and confirmation data. Then, as in step S5-1 described above, the confirmation data is written in the wireless tag 21.

Subsequently, in step S5-6, the CPU 10 sets the transmission output of the first transmitter-receiver 18 at 100 mW according to the table stored in the ROM 112, and as in step S5-2 described above, the confirmation data is read from the wireless tag 21, and then the CPU 10 stores reception confirmation data in the RAM 111.

Subsequently, in step S5-7, the CPU 10 compares the confirmation data stored in the ROM 112 with the reception confirmation data that has just been stored in the RAM 111. If it is found that the two pieces of data are identical and that the first transmitter-receiver 18 and the wireless tag 21 are properly performing RFID wireless communication (S5-7 YES), the transmission output of the first transmitter-receiver 18 is set at 100 mW in step S5-8, and wireless communication between the first transmitter-receiver 18 and the wireless tag 21 continues to be performed at 100 mW.

In step S5-7, if the CPU 10 finds that the two pieces of data are not identical and the first transmitter-receiver 18 and the wireless tag 21 are not properly performing RFID wireless communication, or if, a predetermined time after electromagnetic waves including a read instruction were emitted from the first antenna 19 in step S5-6, electromagnetic waves including confirmation data emitted from the wireless tag 21 have not been fed to the first transmitter-receiver 18 as reception signals and the CPU 10 finds that the first transmitter-receiver 18 and the wireless tag 21 are not properly performing RFID wireless communication (S5-7 NO), the CPU 10 sets the transmission output of the first transmitter-receiver 18 at 120 mW according to the table stored in the ROM 112 in step S5-9. Then, the CPU 10 feeds the first transmitter-receiver 18 with a write instruction and confirmation data stored in the ROM 112, and the first transmitter-receiver 18 converts the write instruction and the confirmation data into transmission signals compatible with RFID. Then, the first transmitter-receiver 18 makes the first antenna 19 emit electromagnetic waves, at the transmission output of 120 mW, including the converted write instruction and confirmation data. Then, as in step S5-1 described above, the confirmation data is written in the wireless tag 21.

Subsequently, in step S5-10, the CPU 10 sets the transmission output of the first transmitter-receiver 18 at 120 mW according to the table stored in the ROM 112, and as in step S5-2 described above, the confirmation data is read from the wireless tag 21, and then the CPU 10 stores reception confirmation data in the RAM 111.

Subsequently, in step S5-11, the CPU 10 compares the confirmation data stored in the ROM 112 with the reception confirmation data that has just been stored in the RAM 111. If the CPU finds that the two pieces of data are identical and that the first transmitter-receiver 18 and the wireless tag 21 are properly performing RFID wireless communication (S5-11 YES), the transmission output of the first transmitter-receiver 18 is set at 120 mW in step S5-12, and wireless communication between the first transmitter-receiver 18 and the wireless tag 21 continues to be performed at 120 mW.

In step S5-11, if the CPU 10 finds that the two pieces of data are not identical and that the first transmitter-receiver 18 and the wireless tag 21 are not properly performing RFID wireless communication, or if, a predetermined time after electromagnetic waves including a read instruction were emitted from the first antenna 19 in step S5-10, electromagnetic waves including confirmation data emitted from the wireless tag 21 have not been fed to the first transmitter-receiver 18 as reception signals and the CPU 10 finds that the first transmitter-receiver 18 and the wireless tag 21 are not properly performing RFID wireless communication (S5-11 NO), the CPU 10 judges that the toner container 20 is not properly fitted in its fitting position, and hence RFID wireless communication is suspended.

As discussed above, in the copier 1 of this embodiment, whether or not RFID wireless communication between the first transmitter-receiver 18 and the wireless tag 21 is possible is judged stepwise at different transmission outputs of the first transmitter-receiver 18 starting at the lower limit value (80 mW in this embodiment), and the transmission output at which RFID wireless communication between them is judged to be possible is used for wireless communication from then on. Hence, it is possible to prevent electromagnetic waves from leaking out of the main body of the apparatus as electromagnetic wave noise. Furthermore, in the copier 1 of this embodiment, since the transmission output of the first transmitter-receiver 18 does not exceed the upper limit value thereof, it is possible to surely prevent electromagnetic waves from leaking out of the main body of the apparatus.

In the embodiment described above, the copier 1 is a monochrome copier, thus has one toner container 20, and thus has one wireless tag 21 fitted thereto. In the case of a color copier, which has a plurality of toner containers, as many wireless tags may be fitted thereto. In this case, as many first transmitter-receiver 18 and first antennas 19 may be added as correspond to the actually provided number of toner containers having the wireless tags fitted thereto. In the case of a revolver-type color copier, in which a plurality of color toner containers containing toners of different colors rotate so as to form a toner image on a photoconductive drum, as the color toner containers rotate, the wireless tag fitted to each color toner container approaches a first transmitter-receiver 18 and a first antenna 19 one after another, and thus each wireless tag can perform wireless communication. Hence, in this case, there may be provided only one transmitter-receiver 18 and one first antenna 19.

In the embodiment described above, it is assumed that a toner container 20 is fitted with a wireless tag 21; in practice, any other replacement part that is detachable from the main body of an apparatus may be fitted with a wireless tag.

In the embodiment described above, it is assumed that wireless communication is performed based on RFID; in practice, the present invention is applicable with any other wireless communication standards.

In the embodiment described above, a copier is dealt with; in practice, the present invention finds wide application in image forming apparatuses in general such as printers and facsimiles as well as copiers.

The present invention may be practiced with various modifications and variations made otherwise than specifically described above within the spirit of the invention.

The present invention is widely applicable to, in addition to copiers, all kinds of image forming apparatuses such as printers and facsimile machines, and offers a technology that is useful for the reduction of electromagnetic wave noise leaking from an apparatus during wireless communication.

What is claimed is:

1. An image forming apparatus, comprising:
a replacement part to which a wireless tag is fitted and that is detachable from a main body of the image forming apparatus;
a transmitter-receiver that performs wireless communication with the wireless tag; and
a checking portion for checking whether or not the transmitter-receiver is properly performing communication with the wireless tag,
wherein,
if the checking portion finds the transmitter-receiver not to be properly performing wireless communication with the wireless tag, the transmitter-receiver gradually increases a transmission output thereof and performs wireless communication.

2. The image forming apparatus of claim 1, further comprising
a memory portion for storing a table in which a plurality of transmission output values are written stepwise from a lower limit value to an upper limit value thereof,
wherein
the transmitter-receiver first performs wireless communication with the wireless tag at the lower limit transmission output value written in the table, and
if the transmitter-receiver is found by the checking portion not to be properly performing wireless communication with the wireless tag, the transmitter-receiver increases the transmission output thereof stepwise according to the table and performs wireless communication.

3. The image forming apparatus of claim 2,
wherein,
when the transmitter-receiver is found by the checking portion to be properly performing wireless communication with the wireless tag, wireless communication is thereafter performed at the transmission output value then being used.

4. The image forming apparatus of claim 2,
wherein,
when the transmitter-receiver performs wireless communication with the wireless tag at the upper limit transmission output value written in the table,
if the transmitter-receiver is found by the checking portion not to be properly performing wireless communication with the wireless tag, the transmitter-receiver suspends wireless communication.

5. The image forming apparatus of claim 3,
wherein,
when the transmitter-receiver performs wireless communication with the wireless tag at the upper limit transmission output value written in the table,
if the transmitter-receiver is found by the checking portion not to be properly performing wireless communication with the wireless tag, the transmitter-receiver suspends wireless communication.
